(19) United States
(12) Patent Application Publication
(10) Pub. No.: US 2016/0246015 A1
(43) Pub. Date: Aug. 25, 2016

(54) MULTIPLE-BEAM MICROLEN

(71) Applicant: CommScope, Inc. of North Carolina, Hickory, NC (US)

(72) Inventors: Richard L. CASE, Omaha, NE (US); Jack L. JEWELL, Boulder, CO (US)

(73) Assignee: CommScope, Inc. of North Carolina, Hickory, NC (US)

(21) Appl. No.: 14/279,198

(22) Filed: May 15, 2014

Related U.S. Application Data
(60) Provisional application No. 61/823,558, filed on May 15, 2013.

(51) Int. Cl. G02B 6/42; G02B 6/43; G02B 6/32; G02B 6/02

(52) U.S. Cl. CPC G02B 6/4206; G02B 6/02042; G02B 6/43; G02B 6/32; G02B 6/4295

(57) ABSTRACT

The invention addresses the coupling of light between one or more multicore fibers and optoelectronic transducers, such as lasers or photodetectors, and/or single core fibers. More specifically, the invention utilizes a single microlens element to couple multiple optical data signals between multiple optoelectronic transducers and multiple cores of a multiple-core fiber (MCF), or to couple signals from multiple single-core fibers to multiple cores of a MCF. At least one optoelectronic transducer and at least one fiber core are substantially removed from the microlens axis and the MCF axis, possibly by different amounts, and cores of the MCF may optionally be polished to be non-telecentric to the axis of the microlens element.

This application claims the benefit of U.S. Provisional Application No. 61/823,558, filed May 15, 2013 and U.S. Provisional Application No. 61/823,588, filed May 15, 2013, which are herein incorporated by reference.

### BACKGROUND OF THE INVENTION

1. Field of the Invention

The present invention relates to a multiple-beam microlens for transference of light between cores of a multi-core fiber (MCF) and optical devices or single core fibers. More particularly, the present invention relates a microlens, or interconnected microlenses forming a microlens array, with each microlens designed to directly couple light from the cores of a MCF to optical devices and/or single core fibers.

2. Description of the Related Art

For applications such as high-performance computing, storage area networks, local area networks, data centers, and others, there is an ever-increasing need for higher-speed optical communication links having higher density in the links, and having higher port density at the ends. “Parallel optical communication” is known in the prior art. In a parallel optical communication system, multiple optical fibers are closely grouped, and terminated in a single connector, typically in a single row or in two rows, such as presented by an MT ferrule or an MPO connector. Typical spacing of the fiber ends at the ferrule's end face or connector face is 250 μm, center-to-center. Each fiber has a single core at its center, which relays an optical data stream in parallel to the data streams being relayed by the other fiber ends presented by the ferrule/connector end face.

An optoelectronic transducer (OET) is a device which converts an electrical data stream to an optical data stream or converts an optical data stream to an electrical data stream. For converting high-speed data streams from electrical to optical, the most prevalent OET is a semiconductor laser, and for parallel optical communications, that is usually a vertical-cavity surface-emitting laser, or VCSEL. For converting high-speed data streams from optical to electrical, the most prevalent OET is a p-i-n photodiode, or PIN. To achieve low cost, a microlens array formed of a molded plastic is typically used to couple light between an array of OETs and an array of fibers, such as the array of fiber ends presented at a ferrule/connector end face in a parallel optical communication system.

Packaging of optoelectronic transducers (OETs) to a circuit board or other structure, and coupling of light beams between OETs and optical fiber ends for higher performance and higher density is a continuing challenge. FIG. 1 illustrates two channels of one end of a parallel optical communication link, in accordance with the prior art. The following description is for an array of optical data streams transmitted by an array of OETs 104, 104′, such as VCSELs, coupled to an array of single core fibers, such as first and second fibers 112, 112′ by a microlens array 100. Each of the first and second fibers 112, 112′ includes a cladding layer 114, 114′ surrounding a central core 116, 116′. The description of the upper channel is the same as for the other channels, such as the lower channel in FIG. 1 having the same reference numerals followed by a prime (′) symbol. Therefore, only the upper channel of FIG. 1 will be described in detail hereinafter.

A first OET 104, a single microlens (upper microlens in FIG. 1) of the microlens array 100, and a first fiber 112 are essentially collinear, as shown by a central axis 102 of the first OET and microlens overlaying a central axis 118 of the first fiber 112. The OET 104 is mounted to a board 144. A Light beam 120 is emitted from the OET 104, collected by a first microlens surface 106, and then relayed through microlens material 108 to a second microlens surface 110. The second microlens surface 110 focuses the light 120 onto an end face 103 of the first fiber 112, more particularly onto an end of the core 116 in the center of the first fiber 112, as presented on a ferrule/connector end face 146.

It should be understood that OETs 104 and 104′ mounted to the board 144 may comprise transmitters, such as a VCSELs for transmitting light to the cores 116 and 116′ of the first and second fibers 112 and 112′ or may be a receivers, such as PIN photodiodes. In the latter case, the light is transmitted from the fiber core 116 of the first fiber 112 to the OET 104 via the microlens element. It is also common for a single row of OETs 104, 104′, . . . mounted on the board surface 144 to comprise both VCSELs and PINs, e.g. four of each, to form the basis of a transceiver, which performs both transmit and receive operations on optical data streams.

In combination, first microlens surface 106, microlens material 108, and second microlens surface 110 constitute a single microlens element of a microlens array 100 for a first communication channel. Similarly, first microlens surface 106′, microlens material 108, and second microlens surface 110′ constitute a single microlens element of the microlens array 100 for a second communication channel. The diameter (D) of the microlens element is smaller than 250 um to allow for manufacturing and correspondence to the typical core-to-core spacing of the single fiber ends presented by an array-type connector. In other words, the distance between central axis 118 and central axis 118′ of the fibers 112 and 112′ in FIG. 1 is approximately 250 um. Hence, the microlens diameter D is smaller than 250 um. Spacing (S) between the OET 104 and a forward edge 142 of first microlens surface 106 is usually more than 350 um, which easily accommodates packaging features, such as wirebonds, which may project 150 um or more above the surface of the OETs 104 or board 144. The thickness (T) of the microlens elements, measured from the forward edge 142 of the first microlens surface 106 to the forward edge 143 of the second microlens surface 110, is about 1 mm.

The potential for high-speed, high-density optical communications using multi-core fibers (MCF) is known. See for example, U.S. Pat. Nos. 5,734,773 and 6,154,594 and U.S. Published Applications 2011/0229085, 2011/0229086 and 2011/0274398, each of which is herein incorporated by reference. The use and speed of multi-mode multi-core fiber (MMMCF), sometimes referred to as multi-core multi-mode fiber (MCMMF), has been demonstrated and published (Lee et al., Journal of Lightwave Technology, vol. 30, No. 6, Mar. 15, 2012). The communication link described by Lee et al. used a MCMMF to relay six optical data streams, each at 20 Gb/s, from six VCSELs to six PIN photodiodes.

The coupling means between the OETs and the cores of the MCFs was simple “butt coupling,” wherein the OETs and cores are located close enough to one another that light is transferred between with sufficient efficiency. Butt coupling suffers from inefficient transfer, and the required close proximity of the cores to the OETs often causes problems with wirebonds or other packaging features used in connection with the OETs. For reasons such as these, butt coupled packages are almost completely absent from commercial, high-speed optical communications products.

The cores of a MCF are positioned much more closely than the prevalent 250 um spacing (axis 118 to axis 118′ in FIG. 1) of single core fibers in a parallel optical communication link. In the demonstration published by Lee et al., the cores of the MCF were 39 um apart. Extending the approach of FIG. 1 to Lee et al.'s configuration would require microlenses about 35 um in diameter, i.e., the distance between axis 102 and 102′ in FIG. 1 would need to be about 35 um. Further, the space S in FIG. 1 would need to be about 60 um. The small space S precludes the use of conventional low-cost wirebonding technology in connection with the OET 104. Furthermore, optical beams having such small diameters will diffract significantly while propagating even over small distances, and the thickness T of the lens array 100 would have to be less than about 650 um, preferably about 500 um, thus having potential issues in manufacturing and in structural stability for the lens array 100.

### SUMMARY OF THE INVENTION

The Applicant has discovered a need in the art for an improved system to couple light between closely-spaced OETs and cores of a MCF. More particularly, the Applicant has developed a coupling system with the properties of high coupling efficiency, adequate space S between OETs and the first surface of the microlens to accommodate a wide range of OET packaging features, e.g., wirebondings, and a microlens thickness T sufficient for mechanical stability and manufacturability.

These and other objects are accomplished by a single microlens element to couple multiple optical data signals between multiple OETs and multiple cores of a MCF. Further, at least one OET and at least one core of a MCF are substantially removed from the microlens element's axis and the MCF axis, possibly by different amounts. Preferably, multiple OETs are positioned approximately equidistant from the microlens axis. Optionally, the microlens element is connected to other microlens elements to form a microlens array.

The Applicant has also appreciated that some applications, i.e. patching, link testing, link monitoring, cross connects, etc. require the optical cores of a MCF to be separated and routed to different termination points. It would be desirable to provide an easy and effective way of routing one or more individual cores of a MCF to different locations.

It is an object of the present invention to address one or more of the needs in the prior art, as appreciated by the Applicant.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limits of the present invention, and wherein:

FIG. 1 is a side view of a lens optical coupling arrangement between single core fibers and OETs, in accordance with the prior art;

FIG. 2 is a side view of a lens optical coupling arrangement between cores of a MCF and OETs, in accordance with the present invention;

FIG. 3A is a side view of a lens optical coupling arrangement between cores of a MCF and OETs illustrate a non-telecentric configuration, in accordance with the present invention;

FIG. 3B is a close up of the end surface of the MCF of FIG. 3A;

FIG. 4 is a side view of a lens optical coupling arrangement model used to generate test data for the present invention;

FIG. 5 is a diagram illustrating performance data of the multi-beam microlens element design of FIG. 4; and

FIG. 6 is a side view of a lens optical coupling arrangement between cores of a MCF and cores of plural single core fibers, in accordance with the present invention.

### DETAILED DESCRIPTION OF EMBODIMENTS OF THE INVENTION

The present invention now is described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

Like numbers refer to like elements throughout. In the figures, the thickness of certain lines, layers, components, elements or features may be exaggerated for clarity. Broken lines illustrate optional features or operations unless specified otherwise.

The terminology used herein is for the purpose of describing particular embodiments only and is not intended to be limiting of the invention. Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. As used herein, phrases such as “between X and Y” and “between about X and Y” should be interpreted to include X and Y. As used herein, phrases such as “between about X and Y” mean “between about X and about Y.” As used herein, phrases such as “from about X to Y” mean “from about X to about Y.”

It will be understood that when an element is referred to as being “on”, “attached” to, “connected” to, “coupled” with, “contacting”, etc., another element, it can be directly on, attached to, connected to, coupled with or contacting the other element or intervening elements may also be present. In contrast, when an element is referred to as being, for example, “directly on”, “directly attached” to, “directly connected” to, “directly coupled” with or “directly contacting” another element, there are no intervening elements present. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper”, “lateral”, “left”, “right” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is inverted, elements described as “under” or “beneath” other elements or features would then be oriented “over” the other elements or features. The device may be otherwise oriented (rotated 90 degrees or at other orientations) and the descriptors of relative spatial relationships used herein interpreted accordingly.

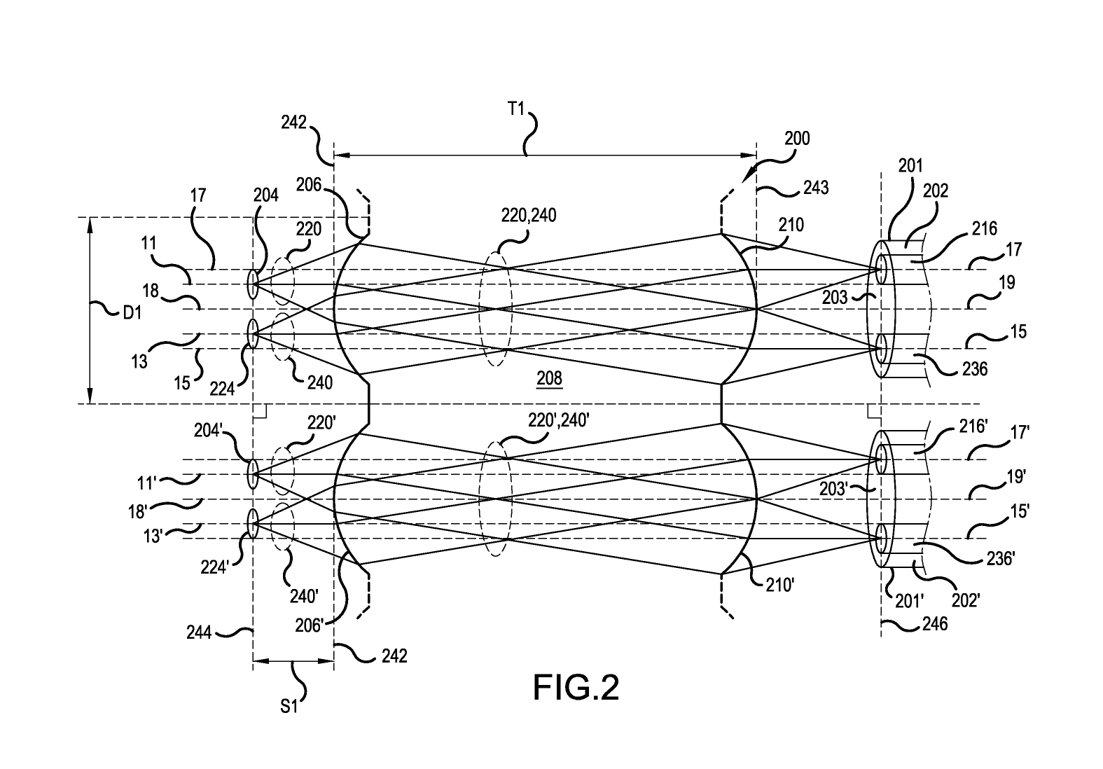

FIG. 2 illustrates two channels of one end of a parallel optical communication link, in accordance with the present invention. The following description is for an array of optical data streams transmitted by an array of OETs 204, 224, 204′ and 224′, such as VCSELs, coupled to first and second MCFs 201 and 201′ by a microlens array 200. Each of the first and second MCFs 201 and 201′ include cladding layers 202 and 202′ surrounding plural cores, such as cores 216 and 236 for the first MCF 201 and cores 216′ and 236′ for the second MCF 201′. The description of the upper channel is the same as for the other channels, such as the lower channel in FIG. 2 having the same reference numerals followed by a prime (′) symbol. Therefore, only the upper channel of FIG. 2 will be described in detail hereinafter.

FIG. 2 shows an embodiment of the present invention, wherein first microlens surface 206, microlens material 208 and second microlens surface 210 constitute a first microlens element of a microlens array 200 for plural communication channels associated with the first MCF 201. Similarly, first microlens surface 206′, microlens material 208, and second microlens surface 210′ constitute a second microlens element of the microlens array 200 for plural communication channels associated with the second MCF 201′. In many cases, multiple microlens elements, e.g. four, eight, twelve or any other number, are fabricated by injection molding of a single piece of plastic to form the microlens array 200.

A preferred plastic to form the microlens array 200 is known as Ultem, although other plastics, glasses, semiconductors, or optical materials may be used instead. Although refractive microlens elements are illustrated in the drawings, the present invention may also employ diffractive lenses, gradient-index lenses, or other types or combinations of lenses.

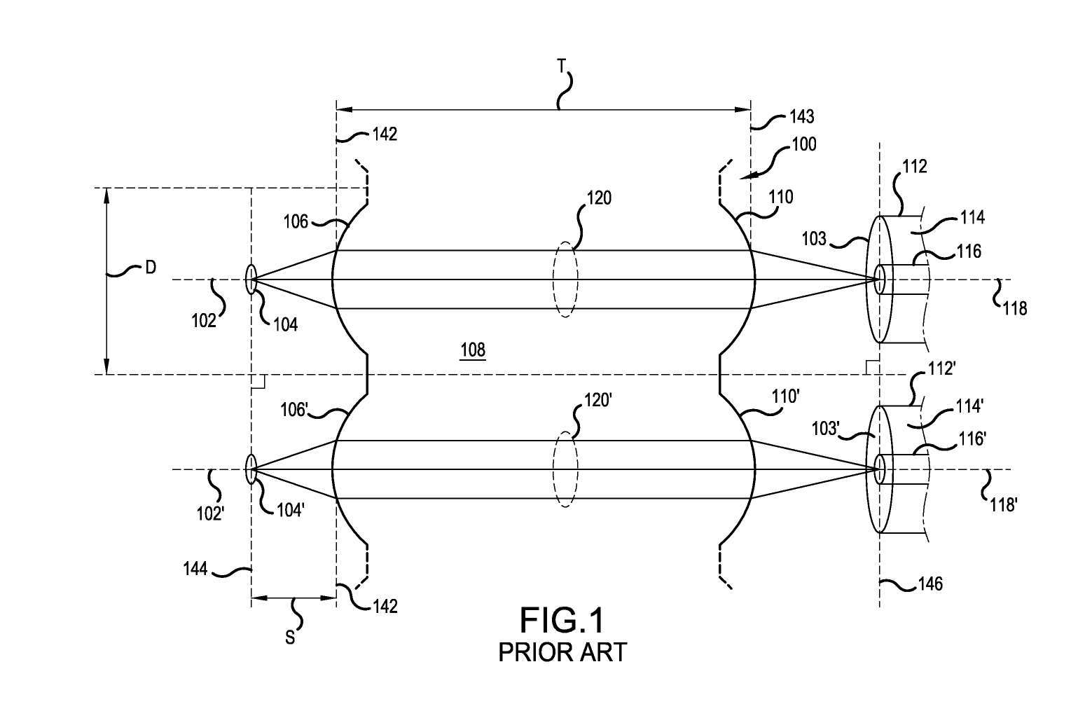

In FIG. 1, each microlens element facilitates a single channel of communication. By contrast, in FIG. 2, each microlens element facilitates plural channels of communication, i.e., the channels represented by the number of cores within a single MCF 201 or MCF 201′. FIG. 2 shows the MCF 201 having two cores 216 and 236 communicating to two OETs 224 and 204, respectively, via a single microlens element. Showing only two cores 216 and 236 and two OETs 204 and 224 is only to simplify FIG. 2. In practice, any number of cores and OETs may be employed per microlens element, such as four, six or eight cores/OETs per microlens element.

The OETs 204 and 224 are mounted to a board 244. A Light beam 220 emitted from the first OET 204 is collected by the first microlens surface 206, and then relayed through microlens material 208 to the second microlens surface 210. The second microlens surface 210 focuses the light 220 onto an end face 203 of the first MCF 201, more particularly onto an end of the second core 236 which extends along an axis 15, offset from a central axis 19 of the first MCF 201, as presented on a ferrule/connector end face 246. A Light beam 240 emitted from the second OET 224 is collected by the first microlens surface 206, and then relayed through microlens material 208 to the second microlens surface 210. The second microlens surface 210 focuses the light 240 onto an end of the first core 216 which extends along an axis 17, offset from the central axis 19 of the first MCF 201.

It should be understood that first and second OETs 204 and 224 mounted to the board 244 may comprise transmitters, such as VCSELs for transmitting light to the second and first cores 236 and 216 of the first MCF 201, or may be a receivers, such as PIN photodiodes. In the latter case, the light is transmitted from the first and second cores 216 and 236 of the MCF 201 to the second and first OETs 224 and 204 via the microlens element. The OETs 204 and 224 mounted on the board surface 244 may comprise both VCSELs and PINs, e.g. two of each, to form the basis of a transceiver, which performs both transmit and receive operations on optical data streams of the MCF 201.

Although FIG. 2 shows two clusters of OETs, with OETs 204 and 224 in the first cluster, and OETs 204′ and 224′ in the second cluster, additional OET clusters, microlens elements, and MCFs may be contained in the same transceiver package. A preferred embodiment comprises a single chip containing four clusters of VCSELs mounted to board 244 and another single chip containing four clusters of PIN photodiodes mounted to board 244. A microlens array 200 comprising one piece of material, e.g. molded plastic, has eight microlens elements, i.e., one microlens element for each OET cluster. Further, eight MCFs are included, with one MCF end align with each microlens element. The MCFs could be presented by an array type ferrule/connector, such as an MT ferrule or MPO connector.

If each MCF had four cores, each cluster would contain four VCSELs or four PIN photodiodes or some combination of VCSELs and PIN photodiodes totally four. If each MCF had eight cores, each cluster would contain eight VCSELs or eight PIN photodiodes or some combination of the two devices totally eight, such as four and four.

The diameter D1 of the microlens element is preferably smaller than 250 um to allow for manufacturing and correspondence to the typical center-to-center spacing of the MCF fiber ends 203, 203′ presented by an array-type connector. In other words, the distance between central axis 19 and central axis 19′ of the MCF fibers 201 and 201′ in FIG. 2 is approximately 250 um, hence the microlens element diameter D1 is smaller than 250 um.

Spacing S1 between the OETs 204, 224, 204′, 224′ and a forward edge 242 of the first microlens surface 206 is usually more than 220 um, which easily accommodates packaging features such as wirebonds, which may project 150 um or more above the surface of the OETs 204, 224, 204′ and 224′ or board 244. The thickness T1 of the microlens elements, measured from the forward edge 242 of the first microlens surface 206 to the forward edge 243 of the second microlens surface 210, is about 0.88 mm.

In FIG. 2, the first core 216 of the MCF 201 has a core axis 17 substantially distanced from the MCF central axis 19 and the second core 236 of the MCF 201 has a core axis 15 substantially distanced from the MCF central axis 19. Preferably, the distances between each core axis 17 and 15 and the MCF central axis 19 are approximately equal. The first OET 204 has an axis 11 coincident to the direction of its central emitted or received beam in light 220, e.g., chief ray. The second OET 224 has an axis 13 coincident to the direction of its central emitted or received beam in light 240, e.g., chief ray. Preferably, the axis 11 of the first OET 204 is distanced from the central axis 18 of the group or cluster of OETs 204 and 224 by an amount which is approximately equal to a distance between the axis 13 of the second OET 224 and the central axis 18.

In FIG. 2, the central axis 19 of the MCF 201 coincides with, e.g., overlies, the central axis 18 of the group or cluster of OETs 204 and 224 communicating with MCF 201. However, it is possible to achieve several of the advantages of the present invention even if the central axis 19 of the MCF 201 is not coinciding with the central axis 18 of the group or cluster of OETs 204 and 224.

The ability of the prior art microlenses element of FIG. 1 to relay an optical beam between an OET 104 and a single, central core 116 of the fiber 112 is substantially degraded when the axis 102 of the OET 104 is substantially distanced from the axis 118 of the microlens element and/or core 116. However, with the configuration of the present invention in FIG. 2, the shapes of the first and second microlens surfaces 206 and 210 are modified to optimize the performance of the microlens element at a given off-axis distance. Performance at other off-axis distances will be less-than optimal, including the prior-art on-axis configuration.

For this reason, it is preferable that the axes 11 and 13 of all OETs 204 and 224 associated with a microlens element are substantially the same distance from the microlens axis, which coincides with the central axis 19 of the MCF 201. Further, it is preferable that the axes 17 and 15 for all cores 216 and 236 associated with a MCF 201 are substantially the same distance from the microlens axis, which coincides with the central axis 19 of the MCF 201.

When the magnification of the microlens element is unity, e.g., 1.0, the axes 11 and 13 of OETs 204 and 224 and axes 17 and 15 of the cores 216 and 236 are all approximately the same distance from microlens/MCF central axis 19, which overlies the central axis 18 of the cluster of OETs 204 and 224. More generally, when the microlens element has a magnification M, the off-axis distances will be different by a factor of M. The example of FIG. 2 has a magnification of approximately 1.5 in the left-to-right direction and approximately 1/1.5 (or ⅔) in the right-to-left direction. Also note that the microlens element “inverts” the positions of the optical data streams 220 and 240, e.g., the first OET 204 above the microlens/MCF central axis 19 is coupled with the second core 236 below the microlens/MCF axis 19. Conversely, the second OET 224 below the microlens/MCF central axis 19 is coupled with the first core 216 above the microlens/MCF axis 19.

An often-desirable feature of a microlens element communication system is that it be “doubly telecentric.” A beam on either side of a lens is telecentric when its chief ray, or central ray, propagates parallel to the lens axis, e.g., approaches the microlens surface parallel to the central axis 19 of the microlens element. When the OET 204 is a VCSEL, and assuming the VCSEL chip surface 244 is perpendicular to microlens/MCF central axis 19 (as shown in FIG. 2), the beam is naturally telecentric, as shown by the central ray propagating parallel to microlens/MCF central axis 19. Similarly, when the beam exits the second microlens surface 210, the central chief ray will again propagate parallel to microlens/MCF central axis 19, and thus be telecentric.

Preferably, the microlens element is designed to have telecentric, or nearly-telecentric, properties on both sides. This condition results in the most efficient fiber coupling, and the greatest tolerance to lateral and longitudinal displacement of the first core 216. Absent a limiting aperture inside the microlens element, in order for the microlens element to be doubly telecentric, its thickness T1 must be optimized in combination with the shapes of the first and second microlens surfaces 206 and 210.

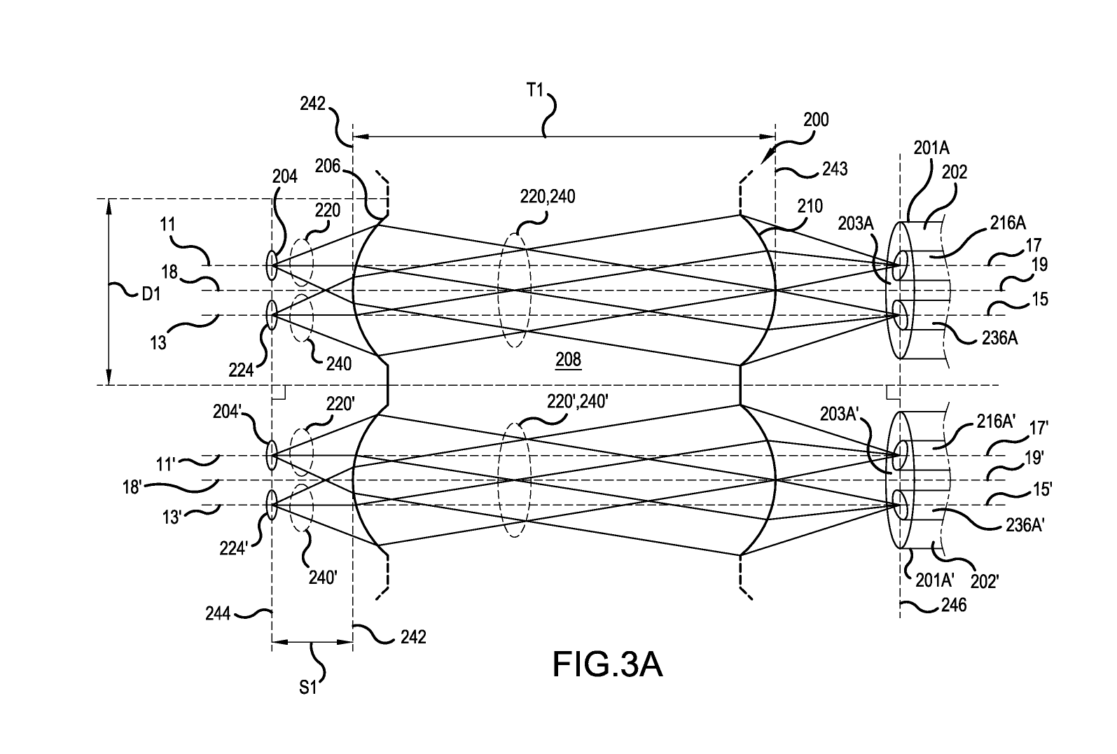

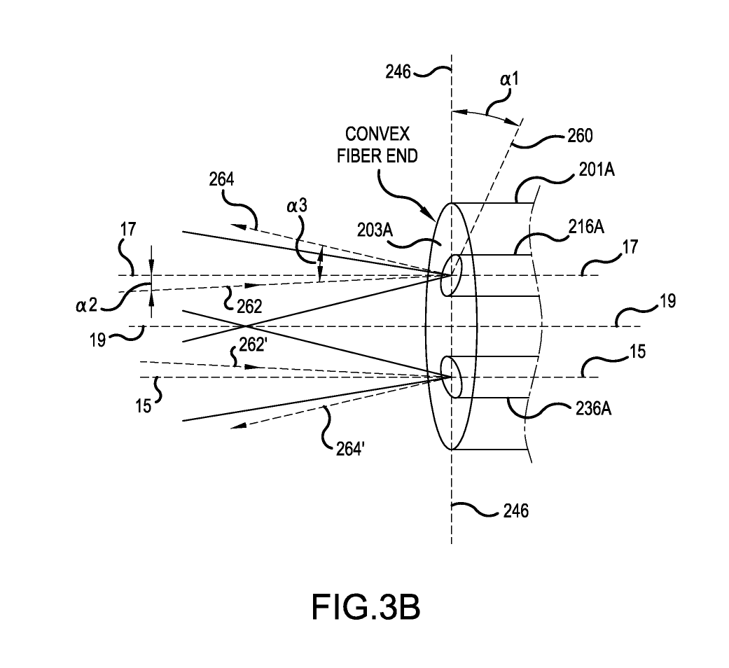

FIG. 3a illustrates a modified embodiment of the present invention, wherein the light beams are telecentric on the OET side of the microlens element, but are slightly non-telecentric on the fiber side of the microlens element. More specifically, the end faces of the first and second cores 216A and 236A are polished at a slight angle, e.g. 4°, angling away from the center of the MCF 201A. For example, the polished angle may be referred to as a facet angle α1 measured between a line 260 flat against the end face 203A of the MCF 201A relative to a line 246 perpendicular to the central axis 19 of the MCF 201A (best seen in FIG. 3B, where the angle has been exaggerated for clarity of illustration).

Preferably, the incident angles above and below the central axis 19 of the MCF 201A have a radial symmetry, e.g. angled away from the central axis 19 of the MCF 201A, and may be produced with an approximately-spherical polish on the end 203A of the MCF 201A. Of course, the other communication channels of the parallel communication system are similar polished. For example, with the second communication channel, the end faces of the first and second cores 216A′ and 236A′ are polished at a slight angle, e.g. 4°. All other structural elements of the embodiment of FIG. 3A may be the same as the embodiment of FIG. 2. However, FIG. 3A differs from FIG. 2 by illustrating that the center axis 11 of the OET 204 may be coincident with the center axis 17 of the first core 216A, and the center axis 13 of the second OET 204 may be coincident with the center axis 15 of the second core 236A. As noted in the embodiment of FIG. 2, typically these center axis will be offset relative to each other, however in some embodiments, depending upon such factors as the diameter of the first and second cores 216A and 236A and the magnification of the microlens element, the central axes 11 and 13 may coincide with the with the central axes 17 and 15, respectively.

In prior preferred embodiments, the incident angle α2 and the facet angle α1 were optimized, such that the chief ray 262 entered the first core 216 along the central axis 17 of the core 216, e.g., the incident angle α2 was approximately zero degrees, e.g., telecentric. The prior preferred configurations of the present invention maximized coupling efficiency and tolerance.

FIG. 3B is a close up view showing the vicinity of the end face 203A of the first MCF 201A in FIG. 3A. As illustrated in FIG. 3B, the present invention applies to conditions wherein the incident angle α2 and the facet angle α1 are not optimized. For example, the incident chief ray 262 may be non-telecentric while the fiber end may be flat, or the incident chief ray may be telecentric while the fiber end angled or curved or the incident chief ray may be non-telecentric while the fiber end angled or curved. FIG. 3B shows both conditions with the chief ray 262 being non-telecentric by incident angle α2 and the end of the fiber 216A being angled or curved by facet angle α1.

The configuration illustrated in FIGS. 3a and 3b is particularly useful for single-mode optical beams, e.g., emitted from a single-mode VCSEL, because the configuration reduces feedback from the end face 203A of MCF 216A into the OET 204, e.g., VCSEL, thus helping to preserve signal quality. Feedback to OET 204 is reduced because the reflection 264 of the chief ray 262 leaves the end face 203A at reflected angle α3. The previous embodiments, which optimized coupling efficiency/tolerance, also maximized feedback into the OET 204 resulting from reflections at the end face 203 of the first fiber 216 because the reflect angle was approximately zero degrees. Hence, an alternative preferred embodiment, as shown in FIGS. 3A and 3B, slightly reduces the coupling efficiency/tolerance of FIG. 2 in order to reduce feedback into the OET 204.

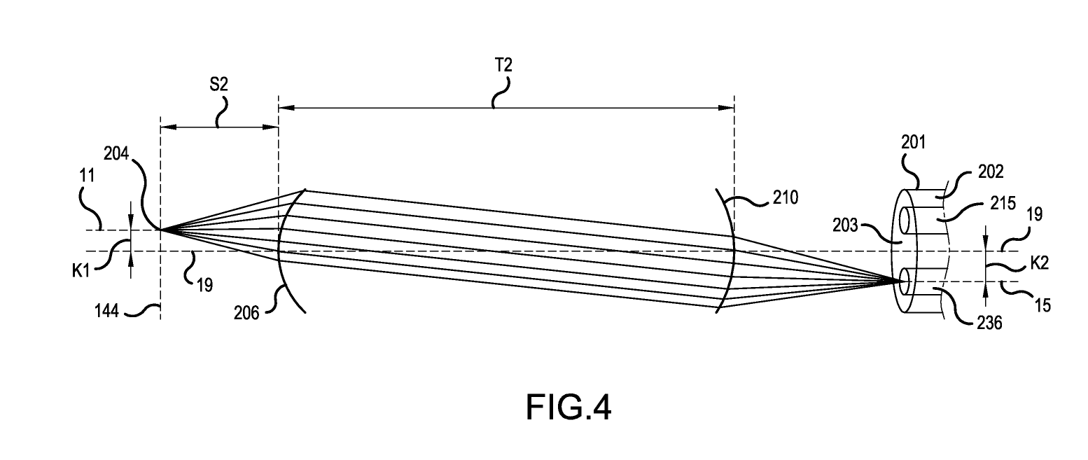

To establish the feasibility of the multi-beam microlens communication system, an optical design was performed, using the Zemax™ lens design/analysis program. As shown in FIG. 4, the design includes a light source 204 formed as a point source having a numerical aperture (NA) of 0.27, simulating a VCSEL on the board 144. The central axis 11 of the point light source 204 is located a distance K1 away from the central axis 19 of the microlens element and MCF 201, where K1 is approximately 39 um. A magnification of the microlens element is set to about 1.5. The central axis 15 of the second core 236 is set a distance K2 from the central axis 19 of the MCF 201, where K2 is approximately equal to 58.5 um.

The distance S2 from the source 204 to the first microlens surface 206 is set to about 220 um. The light beam was approximately collimated inside the microlens material having a refractive index approximating that of Ultem plastic. A thickness T2 of approximately 880 um exists between the first and second microlens surfaces 206 and 210 resulting in approximate telecentricity, as seen by the central (chief) ray propagating approximately along the central axis 15 of the second core 236 on the MCF side of the second microlens surface 210. Conic constants and higher-order aspheric coefficients for first and second microlens surfaces 206 and 210 were varied to minimize the root-mean-square radius and the geometrical radius of the light beam at the second core 236 of the MCF 201.

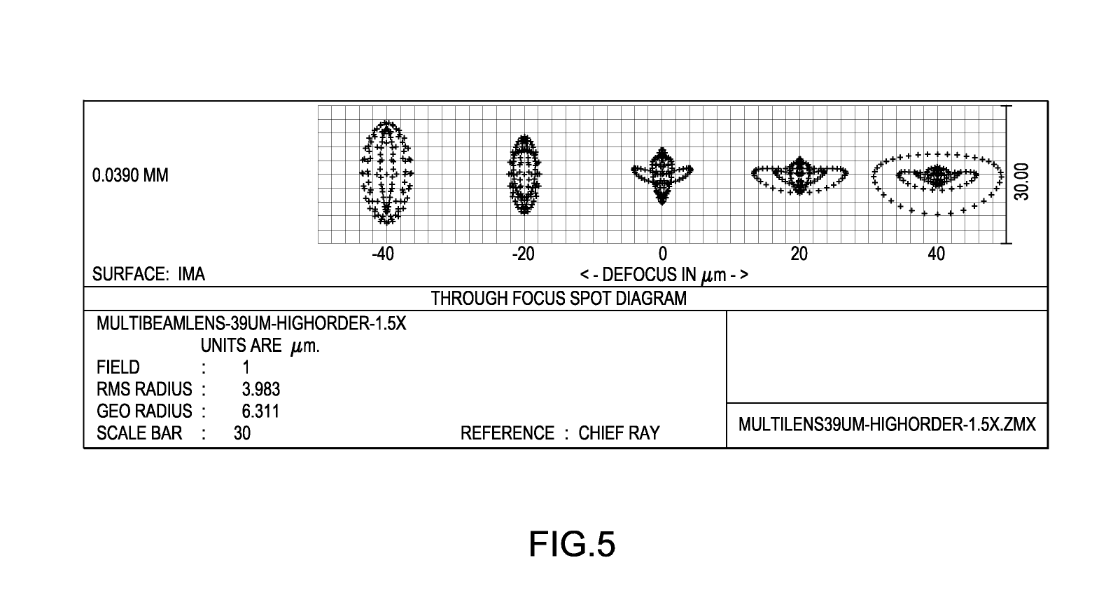

FIG. 5 illustrates the performance of the multi-beam microlens element design with through-focus spot diagrams generated via Zemax™ lens design/analysis program. At the optimal focus location (defocus=0 in FIG. 5), the root-mean-square spot radius is less than 4 um, and the geometrical radius (maximal extent of the traced rays from the spot center) is about 6.3 um.

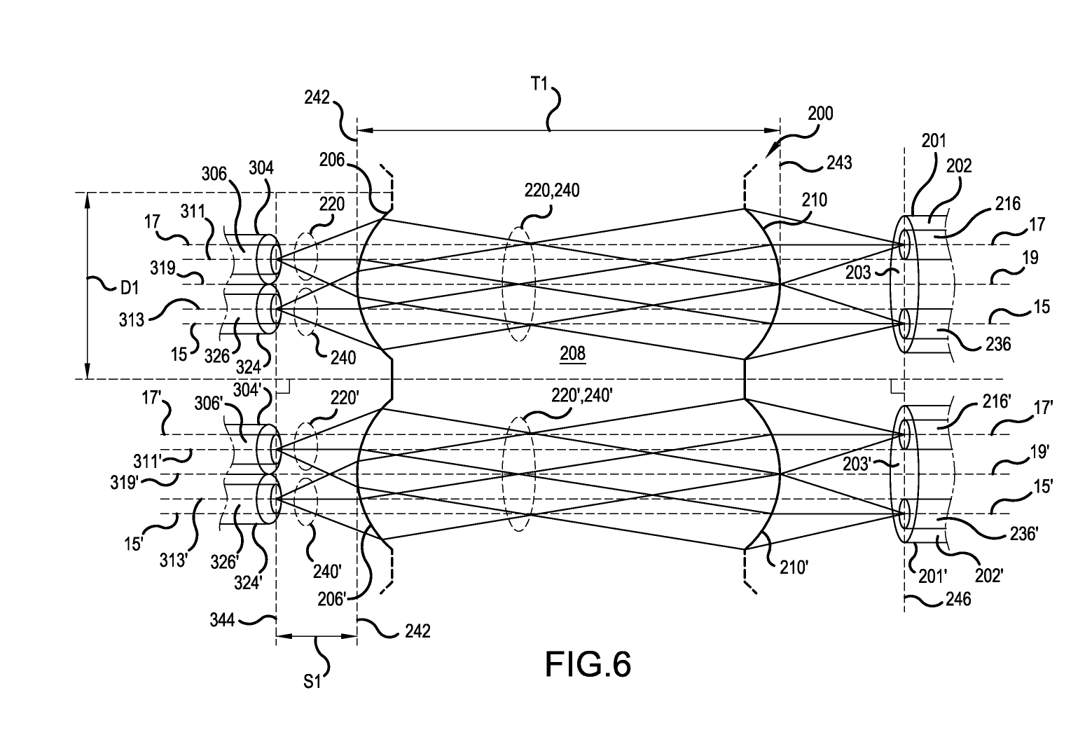

FIG. 6 is a side view of a lens optical coupling arrangement between cores of MCFs 201 and 201′ and cores of plural single core fibers 304, 324, 304′ and 324′, in accordance with the present invention. In FIG. 6, all elements to the right of vertical line 344 are the same as the elements of FIG. 2 and will not be repeated in detailed herein. FIG. 6 illustrates how the microlens elements of the microlens array 200 can be used to couple light signals from the first and second cores 216 and 236 of the first MCF 201 into a core 324 of a second single core fiber 324 and a core 306 of a first single core fiber 304, respectively.

In essence, the OETs 204 and 224 in the embodiment of FIG. 2 have been replaced by the first and second single core fibers 304 and 324. A central axis 311 of the first single core fiber 304 exactly replaces the central axis 11 of the first OET 204 of FIG. 2, and a central axis 313 of the second single core fiber 324 exactly replaces the central axis 13 of the second OET 224 of FIG. 2. A central axis 319 of the cluster of single core fibers exactly replaces the central axis 18 of the cluster of OETs in FIG. 2.

Of course, the cluster of single core fibers could contained more than the two single core fibers depicted in FIG. 6. In a preferred embodiment, the number of single core fibers matches the number of cores in the MCF 201, such as four, six or eight. All of the embodiments and variations discussed above in connection with FIGS. 2, 3A, 3B, 4 and 5, such as non-telecentricity, are applicable to the configuration of FIG. 6.

The configuration of FIG. 6 is useful in the construction of fiber optic jumpers, patch cords, trunk cables, fanouts and other cable configurations that provide optical connectivity in numerous spaces including local area networks (LANs), wide area networks (WANs), datacenters, vehicles, aircraft and ships. Historically, fanouts and jumpers have used one or more single-core optical fibers to mate with one or more single-core optical fibers presented by a termination. With the MCF 201, new fanout designs and new jumper designs are needed to deal with the multiple cores 216 and 236 within the MCF 201 because these cores 216 and 236 cannot be simply separated out of the MCF 201 for redirection or separate termination.

FIG. 6 shows a configuration to provide fanout cordage (left side of FIG. 6) or jumper cordage (again left side of FIG. 6) mated with one or more MCFs 201, 201′ presented by a ferrule end face 246, wherein the cordage is constructed of single-core fibers, e.g., 304, 324, 304′ and 324′, such that terminations at the remote end of the fanout cordage, or at intermediate taps along the jumper cordage, can be made using conventional single core connectors. The Applicant has also appreciated that a jumper with single-core fibers can be used to reorder cores of a MCF from a first end of the jumper to a second end of the jumper. The reordering of the cores may facilitate various connection methods, daisy-chaining patch cords between devices, and/or data security.

By the illustrated configuration of FIG. 6 for connecting multiple cores within one fiber, e.g., a MCF 201, to multiple fibers with single-cores, e.g., single core fibers 304 and 324, the single-core fibers can be terminated by traditional envelopes, e.g., LC, SC, ST, for other uses, as shown in Applicant's co-pending U.S. application Ser. No. 14/170,781, filed Feb. 3, 2014, which is herein incorporated by reference. In the earlier embodiments, it was described how light signals could pass through the microlens element in both directions, e.g., from VCSELs to the MCF 201 or from the MCF 201 to PIN photodiodes. The microlens element in the later embodiments may also pass light signals in both directions, e.g., from the single core fibers 304 and 324 to the MCF 201 or from the MCF 201 to the single core fibers 304 and 324.

The inventive concepts described herein are applicable to any combination of single-mode and multi-mode optical beams, and single-mode and multi-mode fiber cores. The entire lens arrays 200, or at least the microlens elements, of the present invention may be coated with an anti-reflection coating to improve the lens-to-fiber interface and/or reduce reflected rays from the first and second microlens surfaces 206 and 210.

The present invention has been described above in terms of several preferred embodiments. However, modifications and additions to these embodiments will become apparent to persons of ordinary skill in the art upon a reading of the foregoing disclosure. All such modifications and additions comprise a part of the present invention to the extent they fall within the scope of the several claims appended hereto.

1. A method of coupling at least two cores of a multicore fiber to at least two optical devices comprising:
providing a multicore fiber having a first core and a second core;
providing first and second optical devices;
providing a single lens element having a first surface directed toward the multicore fiber and a second surface directed toward the first and second optical devices;
communicating first light signals between the second core and the first optical device through the single lens; and
communicating second light signals between the first core and the second optical device through the single lens.

2. The method of claim 1, wherein the communicating the first light signals and the communicating the second light signals overlap in time.

3. The method of claim 1, wherein the first optical device comprises an optical transmitter, and wherein communicating the first light signals between the second core and the first optical device includes transmitting the first slight signals from the optical transmitter through the first surface of the single lens, with the first light signals passing through no intervening element, then out the second surface of the single lens and into the second core of the multicore fiber, with the first light signals passing through no intervening element.

4. The method of claim 3, wherein the optical transmitter comprises a vertical-cavity surface-emitting laser.

5. The method of claim 1, wherein the first optical device comprises an optical receiver, and wherein communicating the first light signals between the second core and the first optical device includes transmitting the first light signals from the second core of the multicore fiber through the second surface of the single lens, with the first light signals passing through no intervening element, then out the first surface of the single lens and into the optical receiver, with the first light signals passing through no intervening element.

6. The method of claim 5, wherein the optical receiver comprises a p-i-n photodiode.

7. An apparatus having parallel optical communication channels comprising:
a multicore fiber having a first core and a second core;
first and second optical devices;
a single lens element having a first surface directed toward said multicore fiber and a second surface directed toward said first and second optical devices;
first light signals passing between said second core and said first optical device through said single lens; and
second light signals passing between said first core and said second optical device through said single lens.

8. The apparatus of claim 7, wherein said first optical device comprises an optical transmitter, and wherein said first light signals pass from said optical transmitter to said first surface of said single lens, with said first light signals passing through no intervening element, then out said second surface of said single lens and into said second core of said multicore fiber, with the first light signals passing through no intervening element.

9. The apparatus of claim 8, wherein said optical transmitter comprises a vertical-cavity surface-emitting laser.

10. The apparatus of claim 7, wherein said first optical device comprises an optical receiver, and wherein said first light signals pass from said second core of said multicore fiber to said second surface of said single lens, with said first light signals passing through no intervening element, then out said first surface of said single lens and into said optical receiver, with said first light signals passing through no intervening element.

11. The apparatus of claim 10, wherein said optical receiver comprises a p-i-n photodiode.

12. The apparatus of claim 7, wherein said single lens has a center axis and wherein said first core has a center axis, which is radially offset from the center axis of said single lens by a first distance.

13. The apparatus of claim 12, wherein said second core has a center axis, which is radially offset from the center axis of said single lens by a second distance, and wherein said first distance is approximately equal to said second distance.

14. The apparatus of claim 12, wherein said first core is not telecentric to said single lens.

15. The apparatus of claim 14, wherein the center axis of said first core is not parallel to the center axis of said single lens.

16. The apparatus of claim 14, wherein an end face of said first core, facing to said single lens is not perpendicular to the center axis of said single lens.

17. The apparatus of claim 13, wherein said first core is not telecentric to said single lens, and said second core is not telecentric to said single lens.

18. A fanout connector comprising:
a multi-core fiber having at least first and second cores;
a lens; and
first and second single core optical fibers being mounted in a fixed position relative to said lens;
wherein said lens is configured such that first signals from said first core of said multicore fiber entering said lens are directed to said second single core optical fiber and a second signals from said second core of said multicore fiber entering said lens are directed to said first single core optical fiber.

19. The fanout connector of claim 18, wherein said lens has a first side and a second side, wherein said first side of said lens is positioned adjacent to said multicore optical fiber to receive said first and second signals; and wherein said first and second single core optical fibers are positioned adjacent to said second side of said lens; and wherein:
the first signals from said first core of said multicore fiber pass into said first side of said lens at a location a first distance from a central axis of said lens on a first side of the central axis, the second signals from said second core of said multicore fiber pass into said first side of said lens at a location a second distance from the central axis of said lens and on an opposite, second side of the central axis,
the first signals from said first core of said multicore fiber exit said second side of said lens at a location a third distance from the central axis of said lens on the second side of the central axis, and
the second signals from said second core of said multicore fiber exit said second side of said lens at a location a fourth distance from the central axis of said lens on the first side of the central axis.

20. The fanout connector of claim 19, wherein the first distance approximately equals the second distance, and wherein the third distance approximately equals the fourth distance, and wherein the first distance is different from the third distance.
